(19) United States
(12) Patent Application Publication
(10) Pub. No.: US 2021/0225279 A1
(43) Pub. Date: Jul. 22, 2021

(54) PIXEL DRIVE CIRCUIT, DRIVE METHOD, AND DISPLAY PANEL

(71) Applicant: WUHAN CHINA STAR OPTOELECTRONICS SEMICONDUCTOR DISPLAY TECHNOLOGY CO., LTD., Wuhan, Hubei (CN)

(72) Inventors: Tao CHEN, Wuha, Hubei (CN); Jun LI, Wuhan, Hubei (CN)

(21) Appl. No.: 16/302,685

(22) PCT Filed: Aug. 24, 2018
(86) PCT No.: PCT/CN2018/102065

§ 371 Date: Nov. 19, 2018

(30) Foreign Application Priority Data
Jul. 19, 2018 (CN) 201810796516.X

(51) Int. Cl. G09G 3/3233

(52) U.S. Cl. CPC G09G 3/3233; G09G 2300/0852; G09G 2320/043; G09G 2310/08; G09G 2300/0819

(57) ABSTRACT

A pixel driving circuit is provided. The pixel driving circuit comprises a reset module, a compensation module and light emitting module, wherein the reset module is configured to transmit a data signal to the compensation module to reset the compensation module under control of a first driving signal, the compensation module is configured to write the data signal to compensate a threshold voltage under control of a second driving signal, and the light emitting module is configured to emit light under control of a third driving signal.

### FIELD OF INVENTION

The present disclosure relates to a technical field of display, and in particular to a pixel driving circuit, a driving method, and a display panel.

### BACKGROUND OF INVENTION

Organic light emitting diodes (OLEDs) have wide color gamut, high contrast, energy saving, and foldability. Therefore, OLEDs have strong competitiveness in the new generation of displays. Active matrix organic light emitting diodes (AMOLEDs) technology is one of the main development directions of flexible display.

A basic driving circuit of AMOLEDs is shown in FIG. 1 in a 2T1C configuration. The basic driving circuit includes two thin film transistors and a storage capacitor. Specifically, the basic driving circuit has a switching thin film transistor A1, a driving thin film transistor A2, and a storage capacitor C1. A driving current of light emitting element OLED is controlled by the driving thin film transistor A2, and the driving current is I_{OLED}, wherein I_{OLED}=k(V_{gs}−Vₜₕ)², K is driving current amplification factor of the thin film transistor A2, and determined by the characteristics of the driving thin film transistor A2, Vth is a threshold voltage of the driving thin film transistor A2. Due to long hours of operation, the threshold voltage Vth of the driving thin film transistor A2 is shifted, thereby causing a change in the driving current of the light emitting element OLED. Thus, OLEDs are affected, which affects image quality.

In addition, companies have proposed a variety of pixel drive circuits that compensate for threshold voltage drift. However, the pixel drive circuits greatly increase complexity of the metal trace on the display panel and the process of the pixel drive circuits increases difficulty.

### SUMMARY OF INVENTION

An object of the present disclosure is to provide a pixel driving circuit, a driving method and a display panel, which is possible to compensate for the threshold voltage and reduce the metal trace on the display panel, thereby improving the display characteristics of the display panel.

The present disclosure provides a pixel driving circuit, which comprises a reset module, a compensation module and light emitting module. The reset module is configured to receive a first driving signal, and transmit a data signal to the compensation module to reset the compensation module under control of the first driving signal. The compensation module is configured to receive a second driving signal, and write the data signal to compensate a threshold voltage under control of the second driving signal. The light emitting module is configured to receive a third driving signal, and emit light under control of the third driving signal.

In one embodiment of the present disclosure, the reset module includes a fourth thin film transistor and a first storage capacitor, a gate of the fourth thin film transistor is configured to receive the first driving signal; a source of the fourth thin film transistor is connected to the data signal, and a drain of the fourth thin film transistor is connected to the compensation module and an end of the first storage capacitor, and the other end of the first storage capacitor is connected to the second driving signal.

In one embodiment of the present disclosure, the compensation module includes a first thin film transistor, a second thin film transistor, a third thin film transistor and a second storage capacitor, a gate of the first thin film transistor is connected to an end of the second storage capacitor, a drain of the third thin film transistor and the reset module, a drain of the first thin film transistor is connected to the light emitting module and a source of the third thin film transistor, and a source of the first thin film transistor is connected to the light emitting module and a drain of the second thin film transistor, a gate of the second thin film transistor is connected to a gate of the third thin film transistor, the second driving signal and the reset module, the other end of the second storage capacitor is connected to the light emitting module.

In one embodiment of the present disclosure, the light emitting module includes a fifth thin film transistor, a sixth thin film transistor and light emitting component; a gate of the fifth thin film transistor is connected to the third driving signal and a gate of the sixth thin film transistor, a source of the fifth thin film transistor is connected to a first voltage, and a drain of the fifth thin film transistor is connected to the compensation module; a source of the sixth thin film transistor is connected to the compensation module, and a drain of the sixth thin film transistor is connected to an anode of the light emitting component; a cathode of the light emitting component is connected to a second voltage.

In one embodiment of the present disclosure, a capacitance of the first storage capacitor is between 50 fF and 80 fF; a capacitance of the second storage capacitor is between 50 fF and 150 fF; a high voltage level of the second driving signal is between 6V and 9V; a low voltage level of the second driving signal is between −5V and −6V.

In one embodiment of the present disclosure, the first voltage is between 3V and 5V; the second voltage is between −2V and −4V.

In one embodiment of the present disclosure, a driving time sequence of the pixel driving circuit includes a reset stage, a first capacitive coupling moment, a compensation stage, a second capacitive coupling moment and light emitting stage; in the reset step, the first driving signal is a low level, the second driving signal and the third driving signal are high levels, a voltage of the gate of the first thin film transistor is a voltage of the data signal; in the first capacitive coupling moment, the second driving signal is changed from a high level to a low level, a voltage of the gate of the first thin film transistor is a difference between a voltage of the data signal and a voltage of a coupled signal through coupling of the first storage capacitor; in the compensation step, the second driving signal is a low level, the first driving signal and the third driving signal are high levels, a voltage of the gate of the first thin film transistor is a difference between a voltage of the data signal and a threshold voltage of the first thin film transistor; in the second capacitive coupling moment, the second driving signal is changed from a low level to a high level, a voltage of the gate of the first thin film transistor is the sum of a difference between a voltage of the data signal and a threshold voltage of the first thin film transistor and a voltage of the coupled signal through coupling of the first storage capacitor in the light emitting step, the third driving signal is a low level, the first driving signal and the second driving signal are high levels, the pixel driving circuit generates a driving current configured to provide to the light emitting component for driving the light emitting component to emit.

In one embodiment of the present disclosure, the first thin film transistor, the second thin film transistor, the third thin film transistor, the fourth thin film transistor, the fifth thin film transistor and the sixth thin film transistor are p-type thin film transistors.

In one embodiment of the present disclosure, the first driving signal, the second driving signal and the third driving signal are provided from an external timing controller.

The present disclosure further provides a pixel driving circuit, which comprises a first thin film transistor, a second thin film transistor, a third thin film transistor, a fourth thin film transistor, a fifth thin film transistor, a sixth thin film transistor, a first storage capacitor, a second storage capacitor and light emitting component; a gate of the first thin film transistor is connected to an end of the second storage capacitor, an end of the first storage capacitor, a drain of the third thin film transistor and a drain of the fourth thin film transistor, a source of the first thin film transistor is connected to a drain of the second thin film transistor and a drain of the fifth thin film transistor, and a drain of the first thin film transistor is connected to a source of the third thin film transistor and a source of the sixth thin film transistor; a gate of the second thin film transistor is connected to a gate of the third thin film transistor, the other end of the first storage capacitor and the second driving signal; a source of the second thin film transistor is connected to the data signal; a gate of the fourth thin film transistor is connected to the first driving signal; a source of the fourth thin film transistor is connected to the data signal; a gate of the fifth thin film transistor is connected to a gate of the sixth thin film transistor and the third driving signal; a source of the fifth thin film transistor is connected to the other end of the second storage capacitor and a first voltage; a drain of the sixth thin film transistor is connected to an anode of the light emitting component; a cathode of the light emitting component is connected to a second voltage.

In one embodiment of the present disclosure, a capacitance of the first storage capacitor is between 50 fF and 80 fF; a capacitance of the second storage capacitor is between 50 fF and 150 fF; a high voltage level of the second driving signal is between 6V and 9V; a low voltage level of the second driving signal is between −5V and −6V.

In one embodiment of the present disclosure, the first voltage is between 3V and 5V; the second voltage is between −2V and −4V.

In one embodiment of the present disclosure, a driving time sequence of the pixel driving circuit includes a reset step, a first capacitive coupling moment, a compensation step, a second capacitive coupling moment and light emitting step; in the reset step, the first driving signal is a low level, the second driving signal and the third driving signal are high levels, a voltage of the gate of the first thin film transistor is a voltage of the data signal; in the first capacitive coupling moment, the second driving signal is changed from a high level to a low level, a voltage of the gate of the first thin film transistor is a difference between a voltage of the data signal and a voltage of a coupled signal through coupling of the first storage capacitor; in the compensation step, the second driving signal is a low level, the first driving signal and the third driving signal are high levels, a voltage of the gate of the first thin film transistor is a difference between a voltage of the data signal and a threshold voltage of the first thin film transistor; in the second capacitive coupling moment, the second driving signal is changed from a low level to a high level, a voltage of the gate of the first thin film transistor is the sum of a difference between a voltage of the data signal and a threshold voltage of the first thin film transistor and a voltage of the coupled signal through coupling of the first storage capacitor, in the light emitting step, the third driving signal is a low level, the first driving signal and the second driving signal are high levels, the pixel driving circuit generates a driving current configured to provide to the light emitting component for driving the light emitting component to emit.

In one embodiment of the present disclosure, the first thin film transistor, the second thin film transistor, the third thin film transistor, the fourth thin film transistor, the fifth thin film transistor and the sixth thin film transistor are p-type thin film transistors.

In one embodiment of the present disclosure, the first driving signal, the second driving signal and the third driving signal are provided from an external timing controller.

The present disclosure further provides a pixel driving method, which comprises steps of a reset stage, a first capacitive coupling moment, a compensation stage, a second capacitive coupling moment and light emitting stage; in the reset stage, the first driving signal is a low level, the second driving signal and the third driving signal are high levels, a voltage of the gate of the first thin film transistor is a voltage of the data signal; in the first capacitive coupling moment, the second driving signal is changed from a high level to a low level, a voltage of the gate of the first thin film transistor is a difference between a voltage of the data signal and a voltage of a coupled signal through coupling of the first storage capacitor; in the compensation stage, the second driving signal is a low level, the first driving signal and the third driving signal are high levels, a voltage of the gate of the first thin film transistor is a difference between a voltage of the data signal and a threshold voltage of the first thin film transistor; in the second capacitive coupling moment, the second driving signal is changed from a low level to a high level, a voltage of the gate of the first thin film transistor is the sum of a difference between a voltage of the data signal and a threshold voltage of the first thin film transistor and a voltage of the coupled signal through coupling of the first storage capacitor; in the light emitting stage, the third driving signal is a low level, the first driving signal and the second driving signal are high levels, the pixel driving circuit generates a driving current configured to provide to the light emitting component for driving the light emitting component to emit.

The beneficial effect is that the present disclosure provides a pixel driving circuit comprising a reset module, a compensation module, and light emitting module. The reset module is configured to receive the first driving signal, and transmit a data signal to the compensation module to reset the compensation module under control of the first driving signal. The compensation module is configured to receive the second driving signal, and write the data signal to compensate a threshold voltage under control of the second driving signal. The light emitting module is configured to receive a third driving signal, and emit light under control of the third driving signal. In the above manner, it is possible to compensate for the threshold voltage and reduce the metal trace on the display panel, thereby improving the display characteristics of the display panel.

### DESCRIPTION OF DRAWINGS

In order to more clearly illustrate the embodiments or the prior art technical solutions embodiment of the present disclosure, will implement the following figures for the cases described in the prior art or require the use of a simple introduction. Obviously, the following description of the drawings are only some of those of ordinary skill in terms of creative effort without precondition, you can also obtain other drawings based on these drawings embodiments of the present disclosure.

FIG. 1 is a schematic diagram of a conventional pixel driving circuit.

FIG. 2 is a structural schematic diagram of a pixel driving circuit provided according to the present disclosure.

FIG. 3 is a circuit schematic diagram of the pixel driving circuit shown in FIG. 2.

FIG. 4 is a timing diagram of driving signals of the pixel driving circuit shown in FIG. 3.

FIG. 5 is a flowchart of a pixel driving method according to the present disclosure.

FIG. 6 is a schematic diagram of a display panel according to an embodiment of the present disclosure.

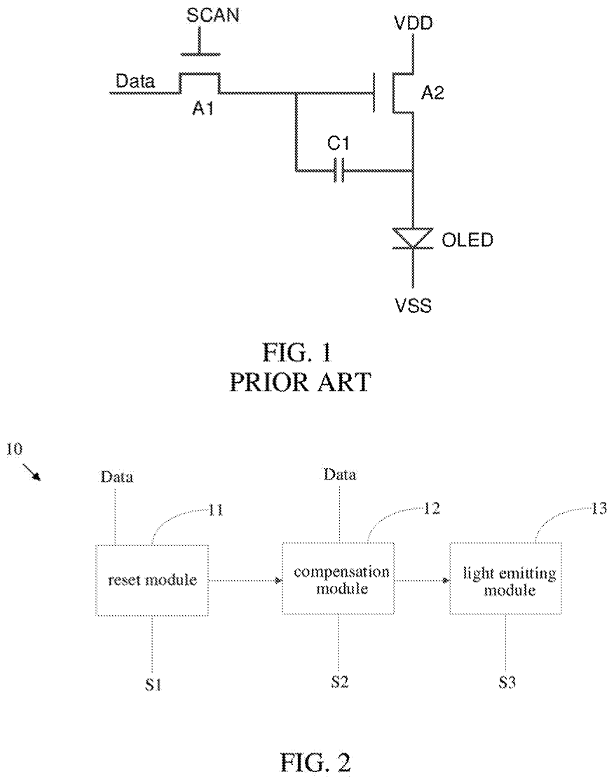

### DETAILED DESCRIPTION OF PREFERRED EMBODIMENTS

Structure and technical means adopted by the present disclosure to achieve the above and other objects can be best understood by referring to the following detailed description of the preferred embodiments and the accompanying drawings. Furthermore, directional terms described by the present disclosure, such as upper, lower, front, back, left, right, inner, outer, side, longitudinal/vertical, transverse/horizontal, etc., are only directions by referring to the accompanying drawings, and thus the used directional terms are used to describe and understand the present disclosure, but the present disclosure is not limited thereto.

Referring to FIG. 2, a structural schematic diagram of a pixel driving circuit provided according to the present disclosure is illustrated. The pixel driving circuit 10 comprises a reset module 11, a compensation module 12, and light emitting module 13, wherein the compensation module 12 is connected to the reset module 11 and the light emitting module 13.

The reset module 11 is configured to receive a first driving signal S1, and transmit a data signal Data to the compensation module 12 to reset the compensation module 12 under control of the first driving signal S1.

The compensation module 12 is configured to receive a second driving signal S2, and write the data signal Data to compensate a threshold voltage under control of the second driving signal S2.

The light emitting module 13 is configured to receive a third driving signal S3, and emit light under control of the third driving signal S3.

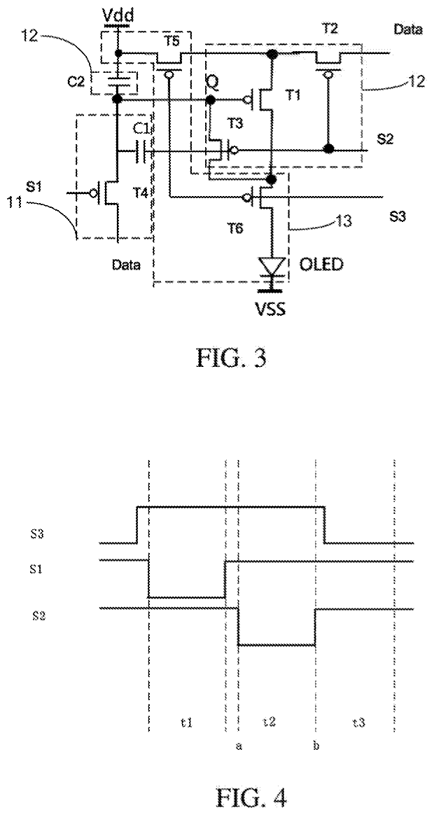

Referring to FIG. 3, a circuit schematic diagram of the pixel driving circuit shown in FIG. 2. is illustrated. The reset module 11 includes a fourth thin film transistor T4 and a first storage capacitor C1. The compensation module 12 includes a first thin film transistor T1, a second thin film transistor T2, a third thin film transistor T3, and a second storage capacitor C2. The light emitting module 13 includes a fifth thin film transistor T5, a sixth thin film transistor T6 and light emitting component OLED.

Specifically, in the reset module 11, a gate of the fourth thin film transistor T4 is configured to receive the first driving signal S1, a source of the fourth thin film transistor T4 is connected to the data signal Data, and a drain of the fourth thin film transistor T4 is connected to the compensation module 12 and an end of the first storage capacitor C1. The other end of the first storage capacitor C1 is connected to the second driving signal S2.

In the compensation module 12, a gate of the first thin film transistor T1 is connected to an end of the second storage capacitor C2, a drain of the third thin film transistor T3, and the reset module 11, a drain of the first thin film transistor T1 is connected to the light emitting module 13 and a source of the third thin film transistor T3, and a source of the first thin film transistor T1 is connected to the light emitting module 13 and a drain of the second thin film transistor T2. A gate of the second thin film transistor T2 is connected to a gate of the third thin film transistor T3, the second driving signal S2 and the reset module 11. The other end of the second storage capacitor C2 is connected to the light emitting module 13.

In the light emitting module 13, a gate of the fifth thin film transistor T5 is connected to the third driving signal S$ and a gate of the sixth thin film transistor T6, a source of the fifth thin film transistor T5 is connected to a first voltage Vdd, and a drain of the fifth thin film transistor T5 is connected to the compensation module 12. A source of the sixth thin film transistor T6 is connected to the compensation module 12, and a drain of the sixth thin film transistor T6 is connected to an anode of the light emitting component OLED.

A cathode of the light emitting component OLED is connected to a second voltage V.

In the embodiment of the present disclosure, in order to ensure a voltage of a coupled signal is greater than a threshold voltage of the first thin film transistor T1, a capacitance of the first storage capacitor C1 is between 50 fF and 80 fF, a capacitance of the second storage capacitor C2 is between 50 fF and 150 fF, a high voltage level of the second driving signal S2 is between 6V and 9V, and a low voltage level of the second driving signal S2 is between −5V and −6V.

Furthermore, the first voltage Vdd is between 3V and 5V; the second voltage Vss is between −2V and −4V.

In the embodiment of the present disclosure, the first thin film transistor T1, the second thin film transistor T2, the third thin film transistor T3, the fourth thin film transistor T4, the fifth thin film transistor T5 and the sixth thin film transistor T6 are p-type thin film transistors. In the circuit design, the thin film transistors of the present disclosure also adopt n-type thin film transistors or the mixed mode of the p-type thin film transistor and n-type thin film transistor. When the thin film transistors are used as switching transistors, the functions of the source and the drain are interchangeable, there is no specific distinction here.

Referring to FIG. 4, a timing diagram of driving signals of the pixel driving circuit shown in FIG. 3 is illustrated. In the embodiment of the present disclosure, the first driving signal S1, the second driving signal S2 and the third driving signal S3 are provided from an external timing controller. Shown in FIG. 4, a driving time sequence of the pixel driving circuit 10 includes a reset stage t1, a first capacitive coupling moment a, a compensation stage t2, a second capacitive coupling moment b and light emitting stage t3.

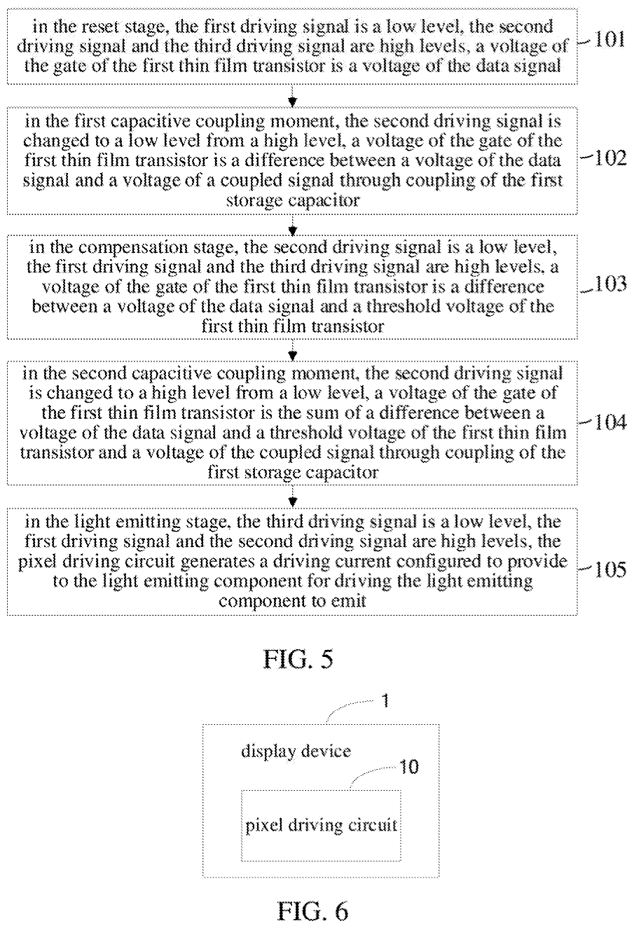

Referring to FIG. 5, a flowchart of a pixel driving method according to the present disclosure is illustrated. A pixel driving method comprising steps of a reset stage, a first capacitive coupling moment 102, a compensation stage 103, a second capacitive coupling moment 104 and light emitting stage 105.

Step 101, in the reset stage, the first driving signal is a low level, the second driving signal and the third driving signal are high levels, a voltage of the gate of a first thin film transistor is a voltage of the data signal.

Step 102, in the first capacitive coupling moment, the second driving signal is changed from a high level to a low level, a voltage of the gate of the first thin film transistor is a difference between a voltage of the data signal and a voltage of a coupled signal through coupling of the first storage capacitor.

Step 103, in the compensation stage, the second driving signal is a low level, the first driving signal and the third driving signal are high levels, a voltage of the gate of the first thin film transistor is a difference between a voltage of the data signal and a threshold voltage of the first thin film transistor.

Step 104, in the second capacitive coupling moment, the second driving signal is changed from a low level to a high level, a voltage of the gate of the first thin film transistor is the sum of a difference between a voltage of the data signal and a threshold voltage of the first thin film transistor and a voltage of the coupled signal through coupling of the first storage capacitor.

Step 105, in the light emitting stage, the third driving signal is a low level, the first driving signal and the second driving signal are high levels, the pixel driving circuit generates a driving current configured to provide to the light emitting component for driving the light emitting component to emit.

In the reset stage t1, the first driving signal S1 is a low level, the second driving signal S2 and the third driving signal S3 are high levels, a voltage of the gate of the first thin film transistor T1 is a voltage of the data signal Data. In the first capacitive coupling moment a, the second driving signal S2 is changed from a high level to a low level, a voltage of the gate of the first thin film transistor T1 is a difference between a voltage of the data signal Data and a voltage of a coupled signal through coupling of the first storage capacitor C1. In the compensation stage t2, the second driving signal S2 is a low level, the first driving signal S1 and the third driving signal S3 are high levels, a voltage of the gate of the first thin film transistor T1 is a difference between a voltage of the data signal Data and a threshold voltage of the first thin film transistor T1. In the second capacitive coupling moment b, the second driving signal S2 is changed from a low level to a high level, a voltage of the gate of the first thin film transistor T1 is the sum of a difference between a voltage of the data signal Data and a threshold voltage of the first thin film transistor T1 and a voltage of the coupled signal through coupling of the first storage capacitor C1. In the light emitting stage t3, the third driving signal S3 is a low level, the first driving signal S1 and the second driving signal S2 are high levels, the pixel driving circuit generates a driving current configured to provide to the light emitting component for driving the light emitting component to emit.

Specifically, in the reset stage t1, the first driving signal is a low level S1, and the second driving signal S2 and the third driving signal are high levels S3. At this time, the fourth thin film transistor T4 is turned on, and the data signal Data received from the source of the fourth thin film transistor T4 is output through the drain of the fourth thin film transistor T4. The gate of the first thin film transistor T1 is connected to the drain of the thin film transistor T4. Thus, the gate of the first thin film transistor T1 is reset to the voltage of the data signal Data.

In the first capacitive coupling moment a, the second driving signal S2 is changed from a high level to a low level, and a voltage of the gate of the first thin film transistor T1 is a difference between a voltage of the data signal Data and a voltage of a coupled signal through coupling of the first storage capacitor C1. It should be note that the voltage of a coupled signal is determined by a change of high or low level of the first storage capacitor C1, the second storage capacitor C2 and the second driving signal S2.

In the compensation stage t2, the second driving signal S2 is a low level, the first driving signal S1 and the third driving signal S3 are high levels, wherein the third thin film transistor T3 is turned on so that a diode connect structure is formed between the gate and the drain of the third thin film transistor T3. The second thin film transistor T2 is turned on, the data signal Data received from the source of the second thin film transistor T2 is written into the drain of the first thin film transistor T1 through the drain of the second thin film transistor T2. The gate is charged to Vdata−|Vth| through the diode connect structure of the first thin film transistor T1, wherein Vth is a threshold voltage of the first thin film transistor T1, and Vdata is a voltage of the data signal Data.

In the second capacitive coupling moment b, the second driving signal S2 is changed from a low level to a high level. A voltage of the gate of the first thin film transistor T1 is the sum of a difference between a voltage of the data signal Data and a threshold voltage of the first thin film transistor T1 and a voltage of the coupled signal through coupling of the first storage capacitor C1. The voltage of the coupled signal is determined by a change of high or low level of the first storage capacitor C1, the second storage capacitor C2 and the second driving signal S2.

In the light emitting stage t3, the third driving signal S3 is a low level, the first driving signal S1 and the second driving signal S2 are high levels. When the fifth thin film transistor T5 and the sixth thin film transistor T6 are turned on, the driving current flowing through the light emitting element OLED satisfies the following formula:

$$\begin{matrix}{I}_{OLED} = {k ( Vdd - ( Vdata - \vert Vth \vert + Vcouple ) - \vert Vth \vert )}^{2} \\ = {k [ Vdd - ( Vdata + Vcouple ) ]}^{2}\end{matrix} ;$$

I_{OLED} is the driving current; Vdd is the first voltage; Vdata is the voltage of the data signal Data; K is a current amplification factor of the first thin film transistor T1; Vcouple is the voltage of the coupled signal; Vth is the threshold voltage of the first thin film transistor T1.

As the described above, the driving current I_{OLED} is substantially independent of the threshold voltage Vth of the first thin film transistor T1. Therefore, the problem that a drift the threshold voltage Vth of the first thin film transistor T1 causes a poor display of the screen can be eliminated.

The present disclosure provides a pixel driving circuit comprising a reset module, a compensation module, and light emitting module. The reset module is configured to receive the first driving signal, and transmit a data signal to the compensation module to reset the compensation module under control of the first driving signal. The compensation module is configured to receive the second driving signal, and write the data signal to compensate a threshold voltage under control of the second driving signal. The light emitting module is configured to receive a third driving signal, and emit light under control of the third driving signal. In the above manner, it is possible to compensate for the threshold voltage and reduce the metal trace on the display panel, thereby improving the display characteristics of the display panel.

Referring to FIG. 6, a schematic diagram of a display panel according to an embodiment of the present disclosure is illustrated. The present disclosure further provides a display panel 1, wherein the display panel 1 includes said pixel driving circuit 10. For details, please refer to the above, and it is not repeat here.

The present disclosure has been described with preferred embodiments thereof and it is understood that many changes and modifications to the described embodiments can be carried out without departing from the scope and the spirit of the invention that is intended to be limited only by the appended claims.

What is claimed is:

1. A pixel driving circuit, comprising:
a reset module, a compensation module, and light emitting module;
wherein the reset module is configured to receive a first driving signal, and transmit a data signal to the compensation module to reset the compensation module under control of the first driving signal;
wherein the compensation module is configured to receive a second driving signal, and write the data signal to compensate a threshold voltage under control of the second driving signal;
wherein the light emitting module is configured to receive a third driving signal, and emit light under control of the third driving signal.

2. The pixel driving circuit according to claim 1, wherein the reset module includes a fourth thin film transistor and a first storage capacitor;
a gate of the fourth thin film transistor is configured to receive the first driving signal, a source of the fourth thin film transistor is connected to the data signal, and a drain of the fourth thin film transistor is connected to the compensation module and an end of the first storage capacitor;
the other end of the first storage capacitor is connected to the second driving signal.

3. The pixel driving circuit according to claim 2, wherein the compensation module includes a first thin film transistor, a second thin film transistor, a third thin film transistor and a second storage capacitor;
a gate of the first thin film transistor is connected to an end of the second storage capacitor, a drain of the third thin film transistor and the reset module, a drain of the first thin film transistor is connected to the light emitting module and a source of the third thin film transistor, and a source of the first thin film transistor is connected to the light emitting module and a drain of the second thin film transistor;
a gate of the second thin film transistor is connected to a gate of the third thin film transistor, the second driving signal and the reset module;
the other end of the second storage capacitor is connected to the light emitting module.

4. The pixel driving circuit according to claim 3, wherein the light emitting module includes a fifth thin film transistor, a sixth thin film transistor and light emitting component;
a gate of the fifth thin film transistor is connected to the third driving signal and a gate of the sixth thin film transistor, a source of the fifth thin film transistor is connected to a first voltage, and a drain of the fifth thin film transistor is connected to the compensation module;
a source of the sixth thin film transistor is connected to the compensation module, and a drain of the sixth thin film transistor is connected to an anode of the light emitting component;
a cathode of the light emitting component is connected to a second voltage.

5. The pixel driving circuit according to claim 4, wherein a capacitance of the first storage capacitor is between 50 fF and 80 fF; a capacitance of the second storage capacitor is between 50 fF and 150 fF; a high voltage level of the second driving signal is between 6V and 9V; and a low voltage level of the second driving signal is between −5V and −6V.

6. The pixel driving circuit according to claim 4, wherein the first voltage is between 3V and 5V and the second voltage is between −2V and −4V.

7. The pixel driving circuit according to claim 4, wherein a driving time sequence of the pixel driving circuit includes a reset stage, a first capacitive coupling moment, a compensation stage, a second capacitive coupling moment and light emitting stage;
in the reset step, the first driving signal is a low level, the second driving signal and the third driving signal are high levels, a voltage of the gate of the first thin film transistor is a voltage of the data signal;
in the first capacitive coupling moment, the second driving signal is changed from a high level to a low level, a voltage of the gate of the first thin film transistor is a difference between a voltage of the data signal and a voltage of a coupled signal through coupling of the first storage capacitor;
in the compensation step, the second driving signal is a low level, the first driving signal and the third driving signal are high levels, a voltage of the gate of the first thin film transistor is a difference between a voltage of the data signal and a threshold voltage of the first thin film transistor;
in the second capacitive coupling moment, the second driving signal is changed from a low level to a high level, a voltage of the gate of the first thin film transistor is the sum of a difference between a voltage of the data signal and a threshold voltage of the first thin film transistor and a voltage of the coupled signal through coupling of the first storage capacitor;
in the light emitting step, the third driving signal is a low level, the first driving signal and the second driving signal are high levels, the pixel driving circuit generates a driving current configured to provide to the light emitting component for driving the light emitting component to emit.

8. The pixel driving circuit according to claim 4, wherein the first thin film transistor, the second thin film transistor, the third thin film transistor, the fourth thin film transistor, the fifth thin film transistor and the sixth thin film transistor are p-type thin film transistors.

9. The pixel driving circuit according to claim 1, wherein the first driving signal, the second driving signal and the third driving signal are provided from an external timing controller.

10. A pixel driving circuit, comprising:
a first thin film transistor, a second thin film transistor, a third thin film transistor, a fourth thin film transistor, a fifth thin film transistor, a sixth thin film transistor, a first storage capacitor, a second storage capacitor and light emitting component;
a gate of the first thin film transistor is connected to an end of the second storage capacitor, an end of the first storage capacitor, a drain of the third thin film transistor and a drain of the fourth thin film transistor, a source of the first thin film transistor is connected to a drain of the second thin film transistor and a drain of the fifth thin film transistor, and a drain of the first thin film transistor is connected to a source of the third thin film transistor and a source of the sixth thin film transistor;
a gate of the second thin film transistor is connected to a gate of the third thin film transistor, the other end of the first storage capacitor and the second driving signal; a source of the second thin film transistor is connected to the data signal;
a gate of the fourth thin film transistor is connected to the first driving signal; a source of the fourth thin film transistor is connected to the data signal;
a gate of the fifth thin film transistor is connected to a gate of the sixth thin film transistor and the third driving signal; a source of the fifth thin film transistor is connected to the other end of the second storage capacitor and a first voltage;
a drain of the sixth thin film transistor is connected to an anode of the light emitting component; a cathode of the light emitting component is connected to a second voltage.

11. The pixel driving circuit according to claim 10, wherein a capacitance of the first storage capacitor is between 50 fF and 80 fF; a capacitance of the second storage capacitor is between 50 fF and 150 fF; a high voltage level of the second driving signal is between 6V and 9V; a low voltage level of the second driving signal is between −5V and −6V.

12. The pixel driving circuit according to claim 10, wherein the first voltage is between 3V and 5V; the second voltage is between −2V and −4V.

13. The pixel driving circuit according to claim 10, wherein a driving time sequence of the pixel driving circuit includes a reset step, a first capacitive coupling moment, a compensation step, a second capacitive coupling moment and light emitting step;
in the reset step, the first driving signal is a low level, the second driving signal and the third driving signal are high levels, a voltage of the gate of the first thin film transistor is a voltage of the data signal;
in the first capacitive coupling moment, the second driving signal is changed from a high level to a low level, a voltage of the gate of the first thin film transistor is a difference between a voltage of the data signal and a voltage of a coupled signal through coupling of the first storage capacitor;
in the compensation step, the second driving signal is a low level, the first driving signal and the third driving signal are high levels, a voltage of the gate of the first thin film transistor is a difference between a voltage of the data signal and a threshold voltage of the first thin film transistor;
in the second capacitive coupling moment, the second driving signal is changed from a low level to a high level, a voltage of the gate of the first thin film transistor is the sum of a difference between a voltage of the data signal and a threshold voltage of the first thin film transistor and a voltage of the coupled signal through coupling of the first storage capacitor;
in the light emitting step, the third driving signal is a low level, the first driving signal and the second driving signal are high levels, the pixel driving circuit generates a driving current configured to provide to the light emitting component for driving the light emitting component to emit.

14. The pixel driving circuit according to claim 10, wherein the first thin film transistor, the second thin film transistor, the third thin film transistor, the fourth thin film transistor, the fifth thin film transistor and the sixth thin film transistor are p-type thin film transistors.

15. The pixel driving circuit according to claim 10, wherein the first driving signal, the second driving signal and the third driving signal are provided from an external timing controller.

16. A pixel driving method, comprising steps of a reset stage, a first capacitive coupling moment, a compensation stage, a second capacitive coupling moment and light emitting stage;
in the reset stage, the first driving signal is a low level, the second driving signal and the third driving signal are high levels, a voltage of the gate of the first thin film transistor is a voltage of the data signal;
in the first capacitive coupling moment, the second driving signal is changed from a high level to a low level, a voltage of the gate of the first thin film transistor is a difference between a voltage of the data signal and a voltage of a coupled signal through coupling of the first storage capacitor;
in the compensation stage, the second driving signal is a low level, the first driving signal and the third driving signal are high levels, a voltage of the gate of the first thin film transistor is a difference between a voltage of the data signal and a threshold voltage of the first thin film transistor;
in the second capacitive coupling moment, the second driving signal is changed from a low level to a high level, a voltage of the gate of the first thin film transistor is the sum of a difference between a voltage of the data signal and a threshold voltage of the first thin film transistor and a voltage of the coupled signal through coupling of the first storage capacitor;
in the light emitting stage, the third driving signal is a low level, the first driving signal and the second driving signal are high levels, the pixel driving circuit generates a driving current configured to provide to the light emitting component for driving the light emitting component to emit.
